(19) United States
(12) Patent Application Publication
(10) Pub. No.: US 2024/0123942 A1
(43) Pub. Date: Apr. 18, 2024

(54) VEHICLE ACCESS

(71) Applicant: Ford Global Technologies, LLC, Dearborn, MI (US)

(72) Inventors: Prashant Dubey, Canton, MI (US); Roy Daniel Chapman, Livonia, MI (US); Christopher Storms, Northville, MI (US)

(73) Assignee: Ford Global Technologies, LLC, Dearborn, MI (US)

(21) Appl. No.: 18/046,167

(22) Filed: Oct. 13, 2022

(51) Int. Cl. B60R 25/25; B60H 1/00; B60Q 1/00; B60Q 1/26; B60R 1/00; B60R 1/12; G06V 10/145; G06V 40/10; G06V 40/14

(52) U.S. Cl. CPC B60R 25/25; B60H 1/00742; B60Q 1/0023; B60Q 1/2665; B60Q 1/2696; B60R 1/006; B60R 1/1207; G06V 10/145; G06V 40/117; G06V 40/14; B60N 2/0248

(57) ABSTRACT

A vehicle puddle lamp assembly including a housing, a lens coupled to the housing, and a printed circuit board mounted to the housing. At least one near-infrared light source to emit near-infrared light through the lens is coupled to the printed circuit board. A palm image sensor is also coupled to the printed circuit board. The palm image sensor is configured to detect a palm vein pattern illuminated by the near-infrared light and reflected from a user's palm through the lens.

### BACKGROUND

Automobiles are secured with locks to prevent unauthorized intrusion and use. Mechanical keys are often used to unlock vehicles. Wireless key fobs can also be used to give users access to vehicles. However, mechanical keys and key fobs can be lost or stolen.

### BRIEF DESCRIPTION OF THE DRAWINGS

FIG. 1 shows an example system for detecting a palm vein pattern.

FIG. 2 shows an exploded view of an example puddle lamp assembly.

FIGS. 3A and 3B show an example method for detecting a palm vein pattern.

FIG. 4 shows an example user profile.

### DETAILED DESCRIPTION

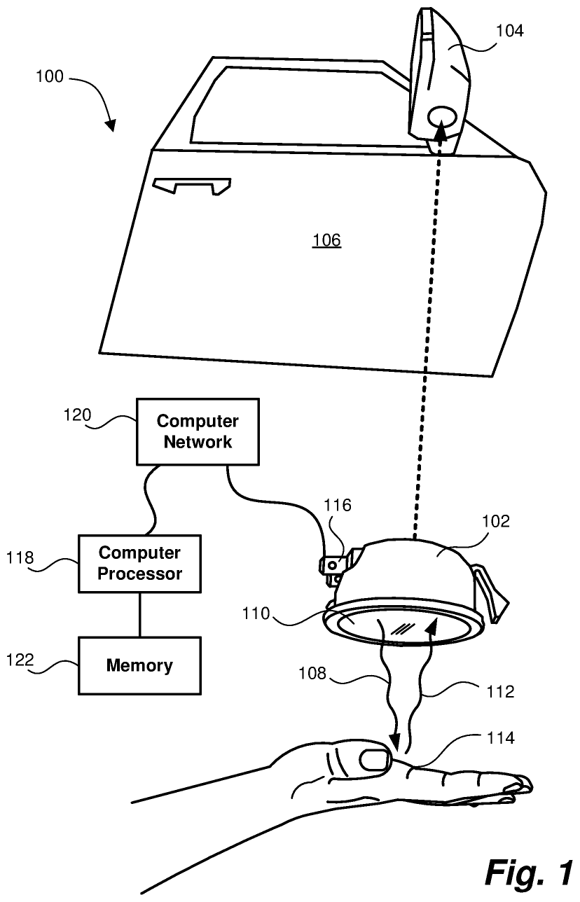

Throughout the description reference is made to FIGS. 1-4. When referring to the Figures, like structures and elements shown throughout are indicated with like reference numerals.

Described herein are systems and methods to identify a vehicle user by employing a palm image sensor. In one exemplary configuration, the palm image sensor is incorporated into a vehicle puddle lamp assembly. The assembly includes a housing, a lens coupled to the housing, and a printed circuit board mounted to the housing. The assembly includes at least one near-infrared light source coupled to the printed circuit board. The near-infrared light source is configured to emit near-infrared light through the lens. The palm image sensor is also coupled to the printed circuit board and is configured to detect a palm vein pattern illuminated by the near-infrared light and reflected from a user's palm through the lens.

The near-infrared light source may be a near-infrared light LED. The vehicle puddle lamp assembly may include a visible light source coupled to the printed circuit board and configured to emit visible light through the lens. The visible light source may be a visible light LED.

The vehicle puddle lamp assembly may include one or more retaining clips on the housing to retain the housing to a side-view mirror. Terminals may be coupled to the printed circuit board to communicate the palm vein pattern to a computer processor through a vehicle network.

Another exemplary configuration includes a system comprising a palm image sensor to detect a palm vein pattern illuminated by near-infrared light and reflected from a user's palm. The system includes a processor and a memory. The memory stores instructions executable by the processor to receive a palm vein pattern of a user from the palm image sensor, access a profile of the user containing at least one reference vein pattern, compare the palm vein pattern to the reference vein pattern, and adjust a cabin target temperature setting of the vehicle based on at least one difference between the palm vein pattern and the reference vein pattern.

The system may include instructions to determine a vein size difference between the palm vein pattern and the reference vein pattern. Furthermore, the instructions to adjust the cabin target temperature setting of the vehicle include instructions to determine the cabin target temperature setting based on the vein size difference and at least one reference temperature associated with the reference vein pattern.

The palm image sensor may be mounted in a puddle lamp assembly, and the puddle lamp assembly may be mounted to a side-view mirror on the outside of the vehicle.

The system may include instructions to authenticate the user based on the palm vein pattern and the reference vein pattern, and to unlock a vehicle door upon authentication of the user. A seat preference may be associated with the reference vein pattern. The system may include instructions to set a seat position of the vehicle to the seat preference upon authentication of the user.

Another implementation may include a method including a receiving step to receive a palm vein pattern of a user from a palm image sensor mounted to an exterior of a vehicle. An accessing step accesses a profile of the user containing at least one reference vein pattern. A comparing step compares the palm vein pattern to the reference vein pattern. A setting step sets a cabin target temperature of the vehicle based on at least one difference between the palm vein pattern and the reference vein pattern.

The method may include determining a vein size difference between the palm vein pattern and the reference vein pattern. The setting step can include calculating the cabin target temperature based on the vein size difference and at least one reference temperature associated with the reference vein pattern.

The method may authenticate the user based on the palm vein pattern and the reference vein pattern and unlock a vehicle door upon authentication of the user. A setting step sets an ambient light level of the vehicle to the ambient light preference associated with the reference vein pattern upon the authentication of the user. Similarly, a setting step sets a seat position of the vehicle to the seat preference associated with the reference vein pattern upon the authentication of the user. A computer may be programmed to carry out the method steps.

FIG. 1 shows an example system 100 for detecting a palm vein pattern. The system 100 includes a puddle lamp assembly 102 mounted in a side mirror 104 of a vehicle 106. It is contemplated the puddle lamp assembly 102 may be mounted to other exterior locations of a vehicle.

The puddle lamp assembly 102 may include a visible light source pointing toward the ground. In this manner, the puddle lamp assembly 102 can illuminate a ground surface when the visible light source is activated. The visible light source may be activated prior to a user entering and exiting the vehicle 106, for example.

As discussed in more detail below, the puddle lamp assembly 102 includes at least one near-infrared light source, such as a near-infrared light LED, that emits near-infrared light 108 through a lens 110. In one configuration, the near-infrared light 108 has a wavelength of approximately 7.6×10⁻⁴ mm. The puddle lamp assembly further includes a palm image sensor to detect reflected near-infrared light 112 passing through the lens 110. The palm image sensor is configured to detect a palm vein pattern illuminated by the near-infrared light 108 and reflected from a user's palm 114 through the lens 110.

The vehicle puddle lamp assembly 102 may include several terminals 116 configured to communicate the palm vein pattern to a computer processor 118 through a vehicle network 120. Communications, i.e., communicative coupling, may be achieved via a controller area network (CAN) bus or local interconnect network (LIN) bus, a wired and/or wireless in vehicle local area network (LAN), e.g., using wired or wireless technologies such as Wi-Fi®, Bluetooth®, etc., as is known. The computer processor 118 can be any of a type of miniature electronic device that contains the arithmetic, logic, and control circuitry necessary to perform the functions of a digital computer's central processing unit, such as a microprocessor, special purpose computer, or other programmable data processing apparatus to produce a machine.

The system 100 includes computer memory 122 storing instructions executable by the computer processor 118. The computer memory 122 can include various volatile and non-volatile memory technologies, such as random-access memory (RAM), read-only memory (ROM), and flash memory. In one configuration, the computer processor 118 and computer memory 122 are part of an automotive electronic control unit (ECU).

The executable instructions may include instructions to receive a palm vein pattern of a user's palm 114 from the palm image sensor. The instructions also access a user profile stored in the computer memory 122. The user profile may include various information, such as reference vein pattern, a reference temperature, an ambient light preference, and a seat preference.

In one implementation of the system 100, the computer memory 122 may include instructions to compare the palm vein pattern acquired by the palm image sensor to the reference vein pattern in the user's profile and to authenticate the user based on the palm vein pattern and the reference vein pattern. The instructions may further cause the computer processor 118 to unlock the vehicle door upon authentication of the user.

The computer memory 122 may include instructions to adjust a cabin target temperature setting of the vehicle 106 based on a difference between the palm vein pattern and the reference vein pattern. In one implementation of the system 100, the instructions may include setting an ambient light level of the vehicle 106 to the ambient light preference upon authentication of the user. The instructions may set a seat position of the vehicle 106 to the seat preference upon authentication of the user. For example, some users may prefer to sit closer to the vehicle's steering wheel, while other users may be more comfortable sitting further away from the steering wheel.

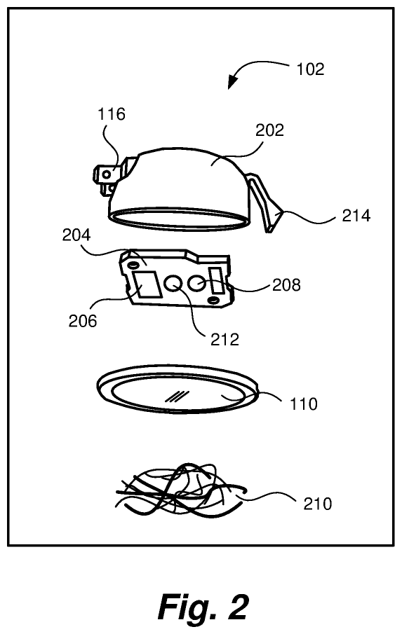

FIG. 2 shows an exploded view of the example puddle lamp assembly 102. The puddle lamp assembly 102 includes a housing 202, a lens 110 coupled to the housing 202, and a printed circuit board (PCB) 204 mounted to the housing 202.

The vehicle puddle lamp assembly 102 may include a visible light source 212, such as a visible light LED, coupled to the PCB 204 and configured to emit visible light through the lens 110. The system 100 may be configured to turn on the visible light source 212 when a user approaches the vehicle 106. This feature provides additional lighting that can assist users to identify obstacles on the ground. The visible light source 212 can reveal ground conditions, such as a ground surface, puddles, etc., when activated.

The puddle lamp assembly 102 further comprises a palm image sensor 206 and at least one near-infrared light source 208 coupled to the PCB 204. As discussed above, the near-infrared light source 208 is configured to emit near-infrared light through the lens 110. The palm image sensor 206 is configured to detect a palm vein pattern 210 illuminated by the near-infrared light and reflected from a user's palm through the lens 110. The palm image sensor may be implemented, for example, as a complementary metal-oxide semiconductor (CMOS) image sensor (CIS), a charge coupled device (CCD), a laser speckle sensor, and a sensor using indium-gallium-sulfur (InGaS). In one implementation, the palm image sensor 206 is a PalmSecure® Sensor F Pro component developed by the Fujitsu Group.

When a user's palm 114 is placed under the puddle lamp assembly 102, the near-infrared light source 208 is activated and a palm vein pattern 210 is captured by the palm image sensor 206. Once the palm vein pattern 210 is captured, it is transmitted to the computer processor 118 for processing. For example, computer instructions stored in computer memory 122 can cause the computer processor 118 to manipulate the palm vein pattern 210 (i.e., scaling and rotating the palm vein pattern) and compare the palm vein pattern 210 to reference vein patterns stored in computer memory 122.

If the computer processor 118 matches the palm vein pattern 210 to a reference vein pattern, the user is authenticated and the vehicle doors are unlocked. The system may further notify the user that authentication was successful by turning on green visible lights and/or beeping a speaker for a short duration in the puddle lamp assembly 102. If the palm vein pattern 210 is not matched to a reference vein pattern, the vehicle may prompt the user that authentication has failed by, for example, turning on red visible lights and/or emitting sound from the speaker for a long duration in the puddle lamp assembly 102.

The vehicle puddle lamp assembly 102 may include terminals 116 coupled to the PCB 204. The terminals 116 may transmit power as well as data and control signals between the PCB 204 and the vehicle. Accordingly, the terminals 116 are configured to communicate the palm vein pattern 210 to the computer processor 118 through the vehicle network 120.

As previously mentioned, the vehicle puddle lamp assembly 102 may be mounted in a side mirror 104 of a vehicle door via any suitable mechanism(s). For example, the housing 202 may include at least one retaining clip 214 to retain the vehicle puddle lamp assembly 102 to the side mirror 104. Other structures for fastening the puddle lamp assembly 102 to a side-view mirror, such as screw holes, may be present on the housing 202.

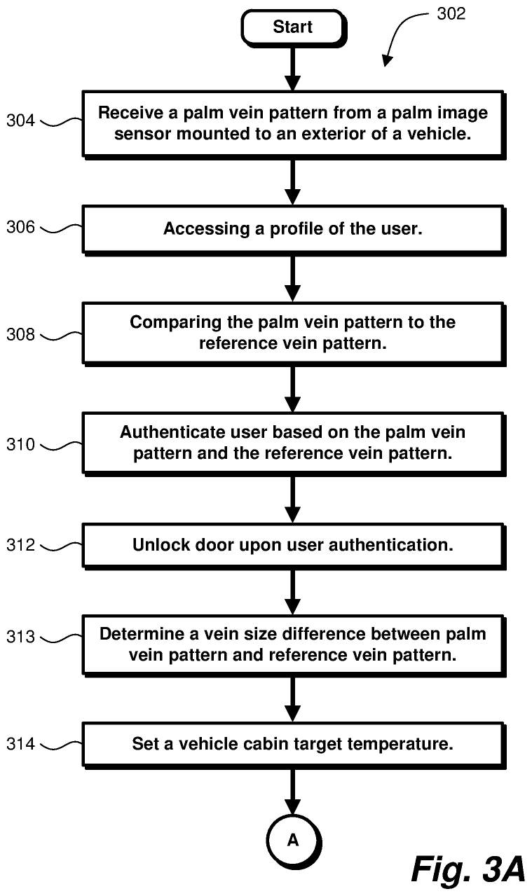

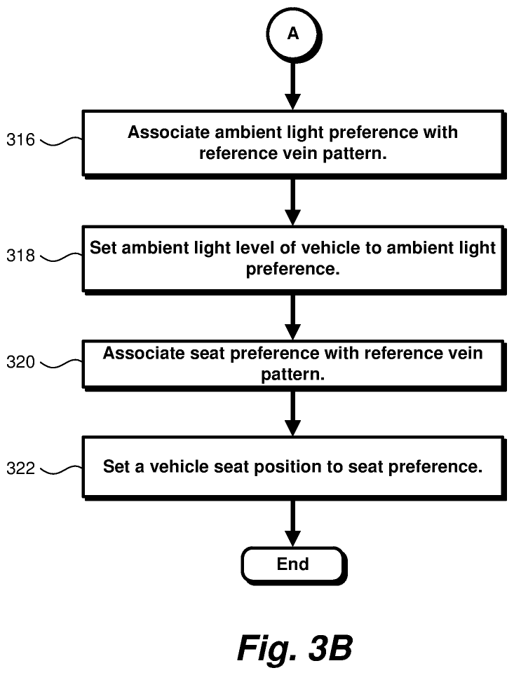

FIGS. 3A and 3B show an example method 302 for detecting a palm vein pattern 210. The method 302 includes receiving operation 304, where a palm vein pattern 210 of a user's palm 114 is received from a palm image sensor 206 mounted to an exterior of a vehicle 106. As detailed above, the palm image sensor 206 may be incorporated into a vehicle puddle lamp assembly 102 mounted in a side mirror 104 of a vehicle 106. It is contemplated the palm image sensor 206 may be mounted at other locations of the vehicle 106.

The palm image sensor 206 may be configured to wake from a sleep mode when a user places their palm 114 next to the sensor. The user's palm 114 is illuminated by the near-infrared light source 208 and reflected from a user's palm through the lens 110. Some of the near-infrared light is reflected from the user's palm 114 back through the lens 110, and into the palm image sensor 206. The deoxidized hemoglobin in the vein vessels absorbs light of wavelength 7.6×10⁻⁴ mm within the near-infrared area. When the palm is illuminated by the near-infrared light, the blood vessel pattern containing the deoxidized hemoglobin is captured as a series of dark lines. The palm image sensor acquires an image of the veins present in the palm using the near-infrared illumination. The sensed palm vein pattern 210 is then digitized.

The receiving operation 304 may include extracting a palm vein pattern 210 with the use of common image processing methods. Examples of the common image processing methods include dark line tracing and linear pattern enhancement through filtering processing. A differentiation filter, such as a one-dimensional space differentiation filter and a two-dimensional space differentiation filter, may be used as the differential filter to extract portions where the amount of change of a difference of pixel gradations values increases. A smoothing filter, such as a Log (Laplacian of Gaussian) filter can be used as the two-dimensional space differentiation filter. Post-processing of palm vein pattern extraction includes, for example, threshold processing, binarization processing, and thinning processing performed on image data after differential filter application. A skeleton of vein patterns can be extracted after undergoing the post-processing. After receiving operation 304, control passes to accessing operation 306.

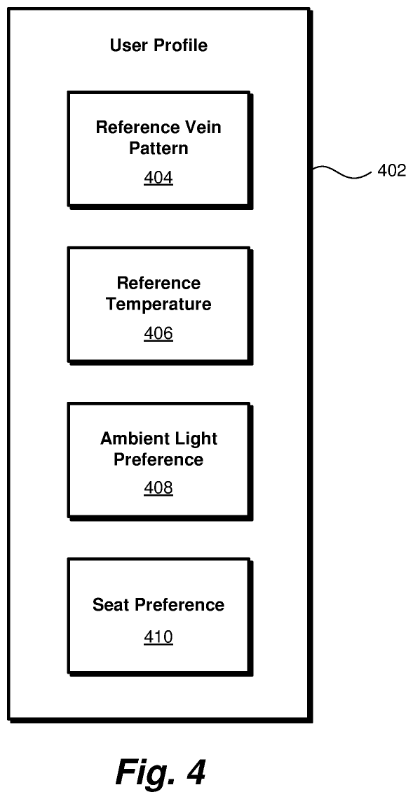

At accessing operation 306, a user profile is accessed. The user profile can be stored in computer memory 122. As shown in FIG. 4, a user profile 402 may include at least one reference vein pattern 404, at least one reference temperature 406, an ambient light preference 408, and a seat preference 410. In one configuration, the user profile 402 is a database record in a user profile database. Returning to FIGS. 3A and 3B, after accessing operation 306, control passes to comparing operation 308.

At comparing operation 308, the palm vein pattern 210 is compared to the reference vein pattern 404 stored in the user profile 402. The comparing operation 308 may, for example, determine a calculated correlation coefficient to make a comparison based on the calculated correlation coefficient. This operation may correct a scale, a point of view, and an orientation of the palm vein pattern 210. Comparing operation 308 may include determining a vein size difference between the palm vein pattern 210 and the reference vein pattern 404. After comparing operation 308, control passes to authenticating operation 310.

At authenticating operation 310, the user is authenticated based on the palm vein pattern 210 and the reference vein pattern 404. The authentication operation 310 translates the lines of the near-infrared image as the reference vein pattern 404 of the palm and matches it with the reference vein pattern 404 of the individual. After authenticating operation 310, control passes to unlocking operation 312.

At unlocking operation 312, a vehicle door is unlocked upon authentication of the user. In one configuration, the user profile is securely stored on a user's mobile device, such as a smartphone application, wirelessly connected to the vehicle's computer network 120. For example, a user may use the mobile device to order an autonomous vehicle or a ride-share vehicle service. When the vehicle arrives, the user's palm is scanned by the palm image sensor 206. The palm vein pattern 210 is then compared against the reference vein pattern 404 stored in the mobile device. If the user is authenticated, the vehicle door is unlocked, and the user is granted access to the vehicle. After unlocking operation 312, control passes to determining operation 313.

At determining operation 313, a vein size difference between the palm vein pattern and the reference vein pattern is determined. When a user's body temperature decreases their palm veins typically shrink. On the other hand, when a user's body temperature increases, their palm veins typically expand to allow more blood through. By determining a difference in palm vein size between the live palm vein pattern and the reference vein pattern the user's relative body temperature can be assessed. After determining operation 313, control passes to setting operation 314.

At setting operation 314, a cabin target temperature of the vehicle is set based on the difference between the palm vein pattern 210 and the reference vein pattern 404. The setting operation 314 includes calculating the cabin target temperature based on the vein size difference between the palm vein pattern 210 and the reference vein pattern 404, as well as the reference temperature 406 associated with the reference vein pattern 404.

In one configuration, the difference in vein size is used as a multiplying factor of the reference temperature 406. A user may have a preferred reference temperature based on their vein size. For example, if the system recognizes the user's vein pattern as being smaller than the reference pattern (say by 30%) that would indicate that their veins have shrunk and their body temperature would be lower than normal (maybe by 1 degree Fahrenheit) so they are likely cold. This results in the multiplying factor to increase the target temperature and/or target fan speed which causes the climate control system to more quickly reach the reference temperature that the user set as comfortable. The target temperature may set initially to a default value and over time the system use learning algorithms to adjust the user's preference profile.

Once the cabin target temperature is set, the vehicle's heater, air conditioner and/or fans can be activated by the computer processor 118 to bring the actual temperature of the cabin to the cabin target temperature. After setting operation 314, control passes to associating operation 316.

At associating operation 316, the ambient light preference 408 is associated with the reference vein pattern 404. Next, at setting operation 318, an ambient light level of the vehicle cabin is set to the ambient light preference 408 upon the authentication of the user. Thus, when the user is authenticated, the ambient lighting is adjusted to the user's preferred setting. After setting operation 318, control passes to associating operation 320.

At associating operation 320, the seat preference 410 is associated with the reference vein pattern 404. Next, at setting operation 322, a seat position of the vehicle is set to the seat preference 410 upon the authentication of the user. It is contemplated that the user profile 402 includes a steering preference and that setting operation 322 includes adjusting the vehicle's steering wheel to the steering preference associated with the reference vein pattern 404. For example, some users may prefer the steering wheel position lower to their knees, while other users may be more comfortable with the steering wheel positioned closer to shoulder height.

The descriptions of the various examples and implementations have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical enhancements over technologies found in the marketplace, or to enable others of ordinary skill in the art to understand the implementations disclosed herein.

As will be appreciated, the methods and systems described may be implemented as a computer program product. The computer program product may include a computer readable storage medium (or media) having computer readable program instructions thereon for causing a processor to carry out operations discussed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry.

Various implementations are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A vehicle puddle lamp assembly, comprising:
a housing;
a lens coupled to the housing;
a printed circuit board mounted to the housing;
at least one near-infrared light source coupled to the printed circuit board, the near-infrared light source configured to emit near-infrared light through the lens; and
a palm image sensor coupled to the printed circuit board, the palm image sensor configured to detect a palm vein pattern illuminated by the near-infrared light and reflected from a user's palm through the lens.

2. The vehicle puddle lamp assembly of claim 1, wherein the near-infrared light source is a near-infrared light LED.

3. The vehicle puddle lamp assembly of claim 1, further comprising a visible light source coupled to the printed circuit board and configured to emit visible light through the lens.

4. The vehicle puddle lamp assembly of claim 3, wherein the visible light source is a visible light LED.

5. The vehicle puddle lamp assembly of claim 1, further comprising at least one retaining clip on the housing configured to retain the housing to a side-view mirror.

6. The vehicle puddle lamp assembly of claim 1, further comprising terminals coupled to the printed circuit board, the terminals configured to communicate the palm vein pattern to a computer processor through a vehicle network.

7. A system, comprising:
a palm image sensor configured to detect a palm vein pattern illuminated by a near-infrared light and reflected from a user's palm;
a processor and a memory, the memory storing instructions executable by the processor, including instructions to:
receive a palm vein pattern of a user from the palm image sensor;
access a profile of the user, the profile including at least one reference vein pattern;
compare the palm vein pattern to the reference vein pattern; and
adjust a cabin target temperature setting of a vehicle based on at least one difference between the palm vein pattern and the reference vein pattern.

8. The system of claim 7, further comprising:
wherein the instructions to compare the palm vein pattern to the reference vein pattern further include instructions to determine a vein size difference between the palm vein pattern and the reference vein pattern; and
wherein the instructions to adjust the cabin target temperature setting of the vehicle further include instructions to determine the cabin target temperature setting based on the vein size difference and at least one reference temperature associated with the reference vein pattern.

9. The system of claim 7, further comprising:
a puddle lamp assembly; and
wherein the palm image sensor is mounted in the puddle lamp assembly.

10. The system of claim 9, further comprising:
a side-view mirror mounted to an exterior of the vehicle; and
wherein the puddle lamp assembly is mounted in the side-view mirror.

11. The system of claim 7, wherein the instructions further include instructions to:
authenticate the user based on the palm vein pattern and the reference vein pattern; and
unlock a vehicle door upon authentication of the user.

12. The system of claim 11, further comprising:
an ambient light preference associated with the reference vein pattern; and
wherein the instructions further include instructions to set an ambient light level of the vehicle to the ambient light preference upon authentication of the user.

13. The system of claim 11, further comprising:
a seat preference associated with the reference vein pattern; and
wherein the instructions further include instructions to set a seat position of the vehicle to the seat preference upon authentication of the user.

14. The system of claim 7, further comprising a near-infrared light LED to emit the near-infrared light.

15. A method comprising:
receiving a palm vein pattern of a user from a palm image sensor mounted to an exterior of a vehicle;
accessing a profile of the user, the profile including at least one reference vein pattern; comparing the palm vein pattern to the reference vein pattern; and
setting a cabin target temperature of the vehicle based on at least one difference between the palm vein pattern and the reference vein pattern.

16. The method of claim 15, further comprising:
determining a vein size difference between the palm vein pattern and the reference vein pattern; and
wherein setting the cabin target temperature of the vehicle further includes calculating the cabin target temperature based on the vein size difference and at least one reference temperature associated with the reference vein pattern.

17. The method of claim 15, further comprising:
authenticating the user based on the palm vein pattern and the reference vein pattern; and
unlocking a vehicle door upon authentication of the user.

18. The method of claim 17, further comprising:
associating an ambient light preference with the reference vein pattern; and
setting an ambient light level of the vehicle to the ambient light preference upon the authentication of the user.

19. The method of claim 17, further comprising:
associating a seat preference with the reference vein pattern; and
setting a seat position of the vehicle to the seat preference upon the authentication of the user.

20. A computer programmed to carry out the method of claim 15.
